(19) United States
(12) Patent Application Publication
(10) Pub. No.: US 2023/0306106 A1
(43) Pub. Date: Sep. 28, 2023

(54) Computer Security Systems and Methods Using Self-Supervised Consensus-Building Machine Learning

(71) Applicant: Bitdefender IPR Management Ltd., Nicosia (CY)

(72) Inventors: Elena BURCEANU, Bucuresti (RO); Emanuela HALLER, Bucuresti (RO); Marius LEORDEANU, Bucuresti (RO); Razvan PREJBEANU, Bucuresti (RO); Constantin D. CERNAT, Bucuresti (RO)

(21) Appl. No.: 17/656,644

(22) Filed: Mar. 26, 2022

(51) Int. Cl. G06F 21/54; G06F 21/55; G06F 21/56; G06K 9/62; G06N 3/04

(52) U.S. Cl. CPC G06F 21/54; G06F 21/554; G06F 21/564; G06K 9/6256; G06N 3/04

(57) ABSTRACT

Some embodiments employ a consensus-building procedure to train a multitask graph comprising a plurality of nodes interconnected by a plurality of edges, wherein each node is associated with a task of determining a set of node-specific attributes of a set of input data, and each edge comprises an AI module (e.g., neural network) configured to determine attributes of an end node according to attributes of a start node of the respective edge. Training fosters consensus between all edges converging to a node. The trained multitask graph may then be deployed in a threat detector configured to determine whether an input set of data is indicative of malice (e.g., malware, intrusion, online threat, etc.).

### BACKGROUND

The invention relates to computer security, and in particular to systems and methods for using unsupervised machine learning to detect emerging computer security threats.

In recent years, computer and network security have become increasingly important for private individuals and companies alike. The rapid development of electronic communication technologies, the increasing reliance on software in daily activities, and the advent of the Internet of Things have left companies and individuals vulnerable to loss of privacy, data theft, and ransom attacks.

Malicious software, also known as malware, is one of the main computer security threats affecting computer systems worldwide. In its many forms such as computer viruses, worms, rootkits, and spyware, malware presents a serious risk to millions of computer users. Malicious intrusion, better known by the popular term ‘hacking’, comprises more focused attacks conducted remotely by human operators, sometimes assisted by malware. Security software may be used to detect both intrusion and malware affecting a user's computer system, and additionally to remove or stop the execution of malware.

Conventional security strategies typically rely on human analysts to devise explicit intrusion and/or malware detection rules and algorithms. For instance, an analyst may use empirical observations and/or insight into the modus operandi of malicious software and hackers to devise behavioral heuristics that are subsequently implemented in security software. However, malicious methods are constantly evolving, so heuristics need to be constantly checked and updated. As the variety of computing devices and the amount of data flowing over information networks increase, it becomes increasingly impractical for human operators to reliably maintain security software. Consequently, computer security is increasingly relying on artificial intelligence (AI) and machine learning technologies to keep up with evolving threats. With their capacity to automatically infer sophisticated models from data, modern artificial intelligence systems (e.g., deep neural networks) have been shown to perform well on such tasks.

However, implementing machine learning for computer security poses its own set of technical challenges. In some of the conventional approaches, training may incur extreme computational costs, may require relatively large training corpora, may be unstable and/or inefficient. Furthermore, reliable training may require annotated data sets, i.e., data already recognized as malicious or benign. Such data is typically expensive to maintain and is not available for emerging threats. There is therefore considerable interest in developing novel detectors and novel methods of training such detectors for computer security applications.

### SUMMARY

According to one aspect, a computer security method comprises employing at least one hardware processor of a computer system to train a plurality of neural network (NN) modules of a graph interconnecting a plurality of nodes. Each node represents a distinct attribute of a set of input data. Each edge comprises a distinct NN module configured to evaluate an attribute associated with an end node of the respective edge according to an attribute associated with a start node of the respective edge. A selected node of the graph receives a plurality of incoming edges, all edges of the plurality of incoming edges configured to evaluate a selected attribute associated with the selected node. Training comprises determining a plurality of values of the selected attribute, each value determined by a NN module associated with a distinct edge of the plurality of incoming edges, and adjusting a parameter of the NN module according to a measure of consensus of the plurality of values. The method further comprises, in response to training the plurality of NN modules, transmitting an adjusted value of the parameter to a threat detector configured to employ another instance of the NN module to determine whether a set of target data is indicative of a computer security threat.

According to another aspect, a computer system comprises at least one hardware processor configured to train a plurality of NN modules of a graph interconnecting a plurality of nodes. Each node represents a distinct attribute of a set of input data. Each edge comprises a distinct NN module configured to evaluate an attribute associated with an end node of the respective edge according to an attribute associated with a start node of the respective edge. A selected node of the graph receives a plurality of incoming edges, all edges of the plurality of incoming edges configured to evaluate a selected attribute associated with the selected node. Training comprises determining a plurality of values of the selected attribute, each value determined by a NN module associated with a distinct edge of the plurality of incoming edges, and adjusting a parameter of the NN module according to a measure of consensus of the plurality of values. The at east one hardware processor is further configured, in response to training the plurality of NN modules, to transmit an adjusted value of the parameter to a threat detector configured to employ another instance of the NN module to determine whether a set of target data is indicative of a computer security threat.

According to another aspect, a non-transitory computer readable medium stores instructions which, when executed by at least one hardware processor of a computer system, cause the computer system to train a plurality of NN modules of a graph interconnecting a plurality of nodes. Each node represents a distinct attribute of a set of input data. Each edge comprises a distinct NN module configured to evaluate an attribute associated with an end node of the respective edge according to an attribute associated with a start node of the respective edge. A selected node of the graph receives a plurality of incoming edges, all edges of the plurality of incoming edges configured to evaluate a selected attribute associated with the selected node. Training comprises determining a plurality of values of the selected attribute, each value determined by a NN module associated with a distinct edge of the plurality of incoming edges, and adjusting a parameter of the NN module according to a measure of consensus of the plurality of values. The instructions further cause the computer system, in response to training the plurality of NN modules, to transmit an adjusted value of the parameter to a threat detector configured to employ another instance of the NN module to determine whether a set of target data is indicative of a computer security threat.

### BRIEF DESCRIPTION OF THE DRAWINGS

The foregoing aspects and advantages of the present invention will become better understood upon reading the following detailed description and upon reference to the drawings where:

FIG. 1 shows a set of client systems collaborating with a security server in detecting computer security threats according to some embodiments of the present invention.

FIG. 2 illustrates an exemplary operation of a threat detector according to some embodiments of the present invention.

FIG. 3 illustrates an exemplary multitask graph comprising a plurality of interconnected AI modules according to some embodiments of the present invention.

FIG. 4 illustrates an exemplary architecture of an AI module according to some embodiments of the present invention.

FIG. 5 shows an exemplary sequence of steps performed during training of the multitask graph according to some embodiments of the present invention.

FIG. 6 shows the structure of an exemplary threat detector according to some embodiments of the present invention.

FIG. 7 illustrates an exemplary sequence of steps performed by the threat detector according to some embodiments of the present invention.

FIG. 8 shows an exemplary computing system configured to carry out some of the methods described herein.

### DETAILED DESCRIPTION OF PREFERRED EMBODIMENTS

In the following description, it is understood that all recited connections between structures can be direct operative connections or indirect operative connections through intermediary structures. A set of elements includes one or more elements. Any recitation of an element is understood to refer to at least one element. A plurality of elements includes at least two elements. Unless otherwise specified, any use of “OR” refers to a non-exclusive or. Unless otherwise required, any described method steps need not be necessarily performed in a particular illustrated order. A first element (e.g. data) derived from a second element encompasses a first element equal to the second element, as well as a first element generated by processing the second element and optionally other data. Making a determination or decision according to a parameter encompasses making the determination or decision according to the parameter and optionally according to other data. Unless otherwise specified, an indicator of some quantity/data may be the quantity/data itself, or an indicator different from the quantity/data itself. A computer program is a sequence of to processor instructions carrying out a task. Computer programs described in some embodiments of the present invention may be stand-alone software entities or sub-entities (e.g., subroutines, libraries) of other computer programs. A process is an instance of a computer program, the instance characterized by having at least an execution thread and a separate virtual memory space assigned to it, wherein a content of the respective virtual memory space includes executable code. Computer readable media encompass non-transitory media such as magnetic, optic, and semiconductor storage media (e.g. hard drives, optical disks, flash memory, DRAM), as well as communication links such as conductive cables and fiber optic links. According to some embodiments, the present invention provides, inter alia, computer systems comprising hardware (e.g. one or more processors) programmed to perform the methods described herein, as well as computer-readable media encoding instructions to perform the methods described herein.

The following description illustrates embodiments of the invention by way of example and not necessarily by way of limitation.

FIG. 1 shows an exemplary set of client systems 10a-c which may collaborate with a security server 12 to detect computer security threats such as malware and intrusion according to some embodiments of the present invention. Client systems 10a-c generically represent any electronic appliance having a processor, a memory, and a communication interface. Exemplary client systems 10a-c include personal computers, corporate mainframe computers, servers, laptops, tablet computers, mobile telecommunication devices (e.g., smartphones), media players, TVs, game consoles, home appliances, and wearable devices (e.g., smartwatches), among others. The illustrated client systems are interconnected by a communication network 15, which may include a local area network (LAN) and/or a wide area network (WAN) such as the Internet. Server 12 generically represents a set of communicatively coupled computer systems, which may or may not be in physical proximity to each other.

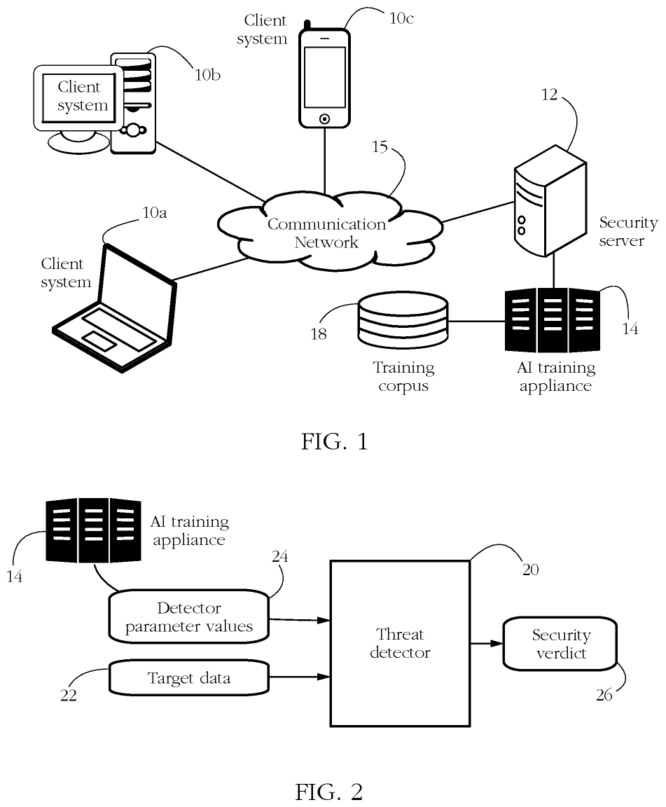

FIG. 2 illustrates the operation of an exemplary threat detector 20 according to some embodiments of the present invention. Threat detector 20 may be embodied as software, i.e., a set of computer programs comprising instructions which, when loaded in a memory and executed by a hardware processor of a computing system such as a personal computer or a smartphone, cause the respective appliance to carry out a task of detecting and/or mitigating a computer security threat. However, a skilled artisan will understand that such embodiments are not meant to be limiting. Instead, detector 20 may be implemented in any combination of software and hardware. For instance, some or all functionality of detector 20 may be implemented in firmware and/or dedicated hardware such as a field programmable gate array (FPGA) or other application-specific integrated circuit (ASIC). The respective hardware module may be highly optimized for the respective functionality, for instance directly implement a particular version of deep neural network architecture and thus enable a substantially higher processing speed than attainable on a general-purpose processor. Furthermore, a skilled artisan will appreciate that distinct components of threat detector 20 and/or of a computer system configured to train detector 20 as described below may execute on distinct but communicatively coupled machines and/or on distinct hardware processors of the same computer system.

Threat detector 20 may be configured to receive a set of target data 22 and in response, to output a security verdict 26 indicating whether the respective target data 22 is indicative of a computer security threat, such as an execution of malicious software or an intrusion, among others. Target data 22 generically represents any data that may be used to infer malicious intent. In various embodiments, exemplary target data 22 may comprise a content of a memory of a client system 10a-c, a sequence of computing events (e.g., system calls, process launches, disk writes, etc.) having occurred on any or multiple client systems 10a-c, a content of an electronic document (e.g. a webpage located at a particular URL, an message exchanged over a messaging service, etc.), and a set of inter-related computing processes, among others. More explicit examples will be described below.

An exemplary security verdict 26 comprises a numerical score indicating a likelihood of a computer security threat. The score may be Boolean (e.g., YES/NO) or may vary gradually between predetermined bounds (e.g., between 0 and 1). In one such example, higher values indicate a higher likelihood of malice. An alternative security verdict 26 may include a classification label indicative of a category of threats (e.g., malware family).

In some embodiments, threat detector 20 comprises a trained AI system, for instance a set of trained artificial neural networks. Training herein denotes adjusting a set of parameters of detector 20 in an effort to improve the performance of detector 20 at a specific task, such as detecting a particular type of threat. Training produces a set of optimized detector parameter values 24 (FIG. 2), which are then used to instantiate detectors 20 executing on clients and/or security server 12. In some embodiments, training of threat detector 20 is carried out by a separate, dedicated computer system, illustrated as AI training appliance 14 in FIG. 1. Appliance 14 may be communicatively coupled to security server 12 and/or client systems 10a-c, and may comprise specialized hardware such as a graphics processing unit (GPU) farm for facilitating the computationally costly training procedures. In some embodiments, the training process uses a training corpus 18 comprising a collection of data samples, at least some of which may be annotated.

In one exemplary scenario, a distinct instance of threat detector 20 may execute on each client system 10a-c, so each client may carry out its own threat detection activities locally and independently. In such cases, detector parameter values 24 resulting from training are transferred to each client and used to instantiate the local instance of detector 20. In an alternative embodiment, threat detector 20 may execute on security server 12, which may thus carry out centralized threat detection activities on behalf of multiple client systems 10a-c. In such embodiments, server 12 may receive target data 22 from each client system 10a-c and return a respective security verdict 26 to the respective client. In one such example, clients 10a-c may access threat detection services via a web interface exposed by security server 12. In such centralized embodiments, security server 12 may operate multiple instances of detector 20 (each instantiated with parameter values 24), and a load balancing service to manage the incoming service demand.

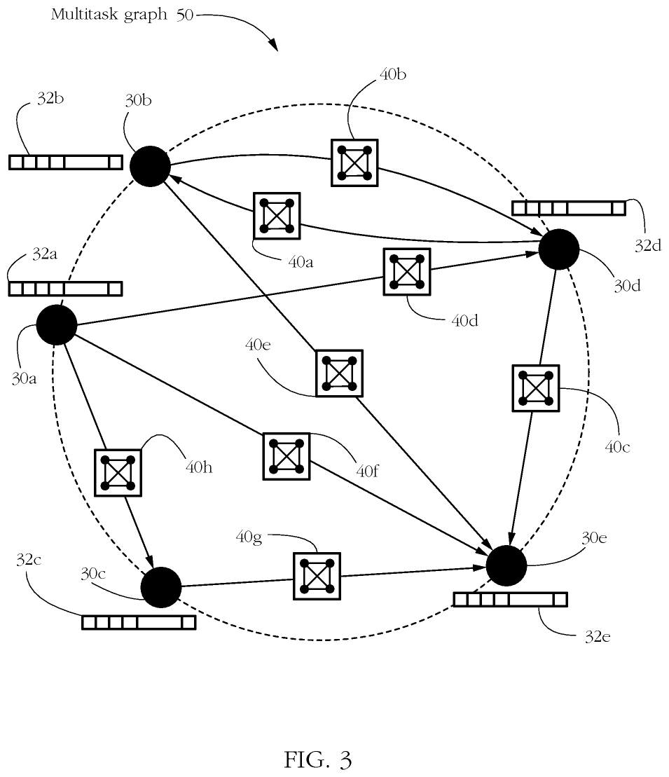

In some embodiments, threat detector 20 comprises a plurality of interconnected AI modules, which may be embodied as individual artificial neural networks. Understanding of the architecture of detector 20 may be facilitated by referring first to FIG. 3, which shows a multitask graph 50 comprising a plurality of nodes 30a-e interconnected by a plurality of directed edges, wherein the direction of each edge is indicated by an arrow. In some embodiments, graph 50 is fully connected, i.e., each node 30a-e is connected to all other nodes. Each node 30a-e represents a task of determining a distinct set of attributes 32a-e of a common set of input data, e.g., target data 22. Each directed edge of the graph represents a transformation from an initial set of attributes associated with a start node to a final set of attributes associated with an end node of the respective edge, wherein the meaning of ‘initial’, start, ‘final’, and ‘end’ is given by the direction of the arrow. Each edge of multitask graph 50 is embodied by a transformation module 40a-h configured to perform the respective transformation. For instance, module 40e transforms attributes 32b into attributes 32e, i.e., determines attributes 32e according to attributes 32b. When a node has multiple incoming edges (e.g., node 30e in FIG. 3), each incoming edge effectively corresponds to a distinct manner of determining the attribute(s) associated with the respective node. In some embodiments, at least some modules 40a-h comprise AI systems (e.g., neural networks).

Intuitively, each distinct node 30a-e and associated attribute set 32a-e may correspond to a distinct ‘view’ or ‘perspective’ of the respective input data. Using an image processing analogy, in an embodiment wherein target data 22 comprises an encoding of an image (i.e., an array of pixel values), each attribute set 32a-e may comprise an array of pixels having the same size as the input image and may give a distinct view or characteristic of the respective image. For instance, attribute set 32b may indicate a set of edges of the respective image (e.g., the value of each element of attribute set 32b may indicate whether the respective image comprises an edge at the respective location), attribute set 32d may indicate a depth (i.e., each pixel value may indicate a physical distance to an object located at the respective location within the input image), and attribute set 32e may correspond to segmentation of the input image (i.e., a division of the input image into multiple regions, each region occupied by a distinct physical object, for instance a wall, bicycle, person, etc., and wherein each pixel value may comprise a label of the respective object). In such an embodiment, exemplary module 40c may comprise an neural network performing an image segmentation (attribute 32e in the above example) according to image depth information (attribute 32d in the above example).

In computer security embodiments, some data attributes 32a-e may also comprise arrays or numbers, and the respective modules 40a-h may consider each element of the array in the context of other elements, as in the image processing analogy above. In one such example, the input data comprises a sequence of computing events, the sequence having a fixed length and being ordered according to a time of occurrence of the respective events. Examples of such events include the launch of a process/thread (e.g., a user launches an application, a parent process creates a child process, etc.), an attempt to access an input device of the respective client system (e.g., camera, microphone), an attempt to access a local or remote network resource (e.g., a hypertext transfer protocol—HTTP request to access a particular URL, an attempt to access a document repository over a local network), a request formulated in a particular uniform resource identifier scheme (e.g., a mailto: or a ftp: request), an execution of a particular processor instruction (e.g., system call), an attempt to load a library (e.g., a dynamic linked library—DLL), an attempt to create a new disk file, an attempt to read from or write to a particular location on disk (e.g., an attempt to overwrite an existing file, an attempt to open a specific folder or document), and an attempt to send an electronic message (e.g., email, short message service—SMS, etc.), among others. A skilled artisan will understand that the systems and methods described herein may be adapted to analyzing other kinds of events, such as events related to a user's activity on social media, a user's browsing history, and a user's gaming activity, among others.

In such embodiments, some of the data attributes 32a-e may have the same size and format as the input data (i.e. array of data), wherein each element may characterize a distinct event of the input event sequence. At least some of modules 40a-h may analyze each event of the sequence according to other events of the sequence, for instance according to another event preceding the respective event and/or according to yet another event following the respective event within the input event sequence.

A skilled artisan will appreciate that the illustrated format of data attributes 32a-e (i.e., as an array of numbers) is given only as an example and is not meant to be limiting. Instead, attributes may be encoded as more complicated data objects. In one example directed at detecting online threats (malicious webpages), the input data may comprise a tree of web documents, wherein a connection between a first and a second documents indicates that the second document is hyperlinked from the first document. Each node of the tree, representing a single document/webpage may have multiple channels, for instance encoding document properties such as a URL, primary code (e.g., HTML), and dynamic code (e.g., executable scripts included in the respective page). Each data attribute 32a-e may have the same tree-like structure as the input data, wherein each attribute value is determined for the respective web page in the input data tree. Exemplary data attributes 32a-e may include, among others:
a blacklist status of the respective page, extracted from multiple sources;
lexical features of the respective page—URL length, URL components length, number of special characters, etc.;
host features characterizing a host server of the respective page—IP address properties, WHOIS info, geolocation, domain name properties, connection speed, etc.;
a page rank of the respective page;
an indicator of a reputation of the respective page;
count and/or proportion of the respective page occupied by advertising;
an indicator of a type of advertising displayed on the respective page (e.g., pop-ups, simple text);
an indicator of a subject matter of the page (e.g., news, banking, education, e-commerce);
a content category of an image displayed on the respective page (e.g., gambling, adult)
an indicator of a level of risk when accessing the respective page;
a category of online threat represented by the respective page (e.g., malware, phishing, defacement);
an indicator of a type of obfuscation used in the URL of the respective page;
an indicator of whether the respective page enables the user to upload data to a remote server;
an indicator of a type of upload data (e.g., images, text, documents);
an indicator of a sentiment of the respective page (e.g., positive, polemical, factual, etc.).

In another example directed at detecting online threats, the input data (e.g., target data 22) comprises a sequence of n webpages accessed consecutively. In an exemplary embodiment when a AI module is configured to distinguish between m classes of online content, an attribute set capturing a result of the classification may comprise a matrix of m×n entries, wherein an attribute value Aᵢⱼ denotes a probability that webpage j belongs to class i.

In another exemplary embodiment directed at detecting malware, the input data may comprise an array wherein each element represents a distinct computer process. For instance, such an embodiment may analyze all processes currently executing on the respective client. Alternative embodiments may analyze all processes belonging to a selected user and/or application. In yet another example, the input may be organized as a graph (e.g., a tree), wherein each node denotes a distinct process, and wherein a connection between two nodes denotes the fact that the two respective processes are related by filiation (e.g., the first process spawned the second one) and/or code injection (e.g., one of the processes has injected code into the other one). Each individual process may be further characterized by multiple channels/features, for instance a file name of an application executed by the respective process, a code entropy of the respective process, a launch command line associated with the respective process, a count and/or a type of API call carried out during execution, a name of a library dynamically linked by the respective process, an amount of resources (e.g., memory) used by the respective process, a memory snapshot (i.e., copy of a logical memory space) of the respective process, etc.

In such embodiments, attributes 32a-e may have the same structure (i.e., array, tree) as the to input/target data, in that each attribute value may characterize a respective process. Exemplary data attributes 32a-e may include, among others:
a likelihood that the respective process is malicious;
a malware category the respective process belongs to;
an application type of the respective process (e.g., game, word processor, browser);
an indicator of a type of resource used by the respective process;
an anomaly score determined for the respective process;
a sandbox security level associated with the respective process;
indicators related to inter-process communication: high/low level of interaction with other processes or entities, inside/outside communication, intranet/internet, private/public.

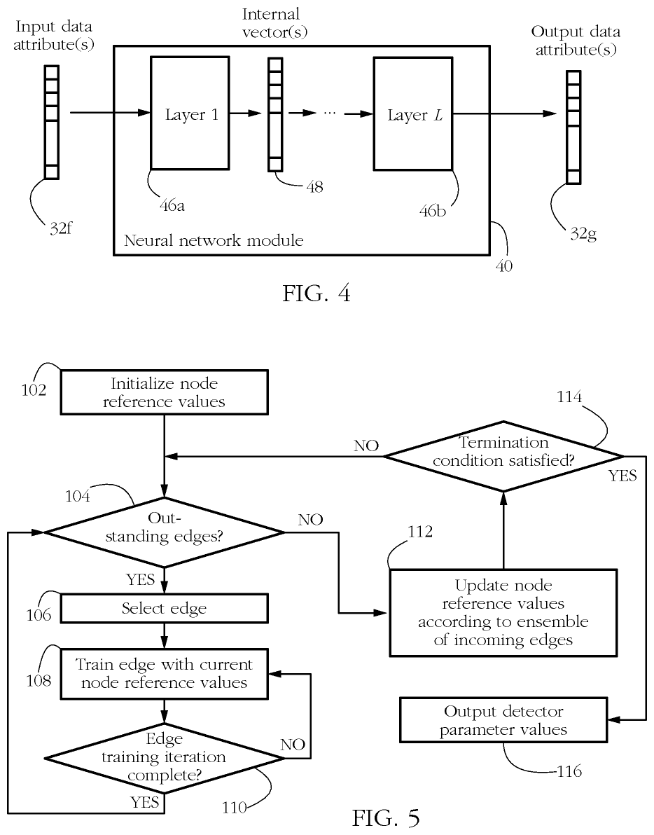

Modules 40a-h (FIG. 3) may be constructed using various methods and technologies. In some embodiments, at least a subset of modules 40a-h comprise AI systems, for instance artificial neural networks. FIG. 4 shows an exemplary architecture of a neural network module 40. The illustrated module comprises a deep neural network including a stack of neuron layers 46a-b, each layer receiving the output of the previous layer/module and providing input to the next layer of the stack. Each consecutive layer Lᵢ transforms the input received from the previous layer according to a set of parameters (e.g., weights, biases) specific to the respective layer, to produce an internal vector 48, the size and range of values of which may vary among the distinct layers of module 40. For instance, some layers achieve a dimensionality reduction of the respective input vector, as in the case of a pooling layer.

The type and architecture of each layer may differ across embodiments. Some embodiments rely on the observation that architectures that analyze information in context may be beneficial for malware detection, since they enable correlating information across multiple items (e.g., multiple URL's, multiple processes, etc.). One such exemplary architecture of AI module 40 comprises a convolutional layer followed by a dense (i.e., fully connected) layer further coupled to a rectifier (e.g., ReLU or other activation function). Alternative embodiments may comprise a convolutional layer feeding into a recurrent neural network (RNN), followed by fully connected and activation layers. Convolutional layers effectively multiply an input attribute array 32f with a matrix of weights known in the art as filters, to produce an embedding tensor so that each element of the respective tensor has contributions from a selected element of the input array, but also from other elements of the input array adjacent to the selected element. The embedding tensor therefore collectively represents input attribute(s) 32f at a granularity that is coarser than that of individual elements. The filter weights are adjustable parameters which may be tuned during the training process.

Recurrent neural networks (RNN) form a special class of artificial neural networks, wherein connections between the neurons form a directed graph. Several flavors of RNN are known in the art, including long-short-term-memory (LSTM) networks and gated recurrent units (GRU), among others. An RNN layer may process information about each element of input attribute array 32f in the context of adjacent elements of the array. Other exemplary architectures of AI module 40 that analyze information in context comprise graph neural network (GNN) and transformer neural network. The transformer architecture is described, for instance, in A. Vaswani et al., ‘Attention is all you need’, arXiv:1706.03762.

In some embodiments, at least some of modules 40a-h of multitask graph 50 (FIG. 3) are co-trained via a consensus-building machine learning algorithm as illustrated in FIG. 5. The illustrated sequence of steps may be performed by AI training appliance 14. The term ‘training’ herein denotes a machine learning procedure whereby an AI system (e.g., a neural network) is presented with a variety of training inputs and is gradually tuned according to the outputs that the respective inputs produce. For each training input/batch, training may comprise processing the respective input to produce a training output, determining a value of a problem-specific utility function according to the respective training output and/or input, and adjusting a set of parameters of the respective AI system according to the respective utility value. Adjusting the parameters may aim for maximizing (or in some cases, minimizing) the utility function. In one example of training a neural network, adjustable parameters may include a set of synapse weights and neuron biases, while the utility function may quantify a departure of the training output from an expected or desired output. In such an example, training may comprise adjusting synapse weights and possibly other network parameters so as to bring the training output closer to the desired output corresponding to the respective training input. In some embodiments, the number of adjustable parameters of a typical detector 20 may vary from several thousand to several million. Training may proceed until a termination condition is satisfied. For instance, training may be carried out for a pre-determined number of epochs and/or iterations, for a pre-determined amount of time, or until a desired level of performance is reached. Co-training herein denotes a collective training wherein each participating module 40a-h is not trained in isolation, but instead is influencing and/or is influenced by changes in another module of network 50.

In some embodiments, training uses a corpus 18 of training samples/inputs having the same format as target data 22 that the respective threat detector is expected to process. Some training samples may be annotated, i.e., may comprise various data attribute values 32a-e pre-computed for each respective training sample. In a step 102, AI training appliance 14 may initialize all nodes of multitask graph 50 with a respective reference value comprising a value of the respective data attribute determined for the respective training sample. When training data is annotated, the respective reference value may be directly retrieved from corpus 18, for each training sample. When no pre-determined reference attribute value is available for a node, some embodiments employ a per-task expert model to provide one for each training sample. In another exemplary embodiment, a node may be initialized with the output of a selected incoming edge. Taking the example of FIG. 3, node 30e may be initialized by executing edge 40f.

Having provided reference attribute values for each node of graph 50, some embodiments then enter a cycle of edge training illustrated by steps 104-110 in FIG. 5. For each edge, a step 108 may train the respective module 40a-h to map the respective reference values of its end nodes. In some embodiments, step 108 comprises determining a utility function according to a difference between the reference value of the destination node and a predicted value determined by the respective AI module according to the reference value of the source node of the respective edge. Step 108 then further comprises adjusting the internal parameters of the respective module (e.g., synapse weights, etc.) to reduce the utility function. The operation may be repeated for each training sample of corpus 18, until a termination condition is satisfied (step 110). Based on the observation that in this stage of the training process, edges may be trained independently of each other, some embodiments carry out steps 104-110 in a parallel computing configuration. For instance, computations related to training two distinct edges may be carried out simultaneously on two distinct processor cores, etc.

When all edges have been trained on the initial reference attribute values, a step 112 may update the respective reference values. Some embodiments update a node's reference attribute value according to an ensemble of edges incoming to the respective node. For each node 30a-e, each incoming edge produces a prediction for the attribute value(s) of the respective node. In some embodiments, step 112 uses this fact to replace the respective node's current reference attribute value(s) with a new reference value comprising a combination of prediction values provided by each individual incoming edge. An exemplary combination includes a weighted average wherein the importance of each edge to the combination is quantified by a numerical weight.

Since distinct edges converging on a node are in essence just distinct ways of computing the same attribute, the predictions given by all incoming edges should coincide. In practice this does not happen, because individual predictions are not perfect. Some embodiments rely on the observation that a consensus between incoming edge predictions is likely to indicate a correct value of the respective attribute. Therefore, some embodiments effectively use consensus as a training tool, for instance as a training supervisory signal.

Some embodiments co-train all edges that converge on a node according to a measure of consensus between the respective edges, by actively driving the respective edges towards increased consensus. A consensus between two edges is herein meant to increase when their respective predictions get closer together.

Consensus may be used in various ways as a supervisory signal. In some embodiments, a measure of consensus is determined according to a set of distances between a prediction value computed by each edge converging onto a node and a reference value of the respective node, and wherein large distances indicate a low consensus. The reference value may be provided by an outside authority (as in an annotation or an output of an expert model, see step 102 above), or by one of the respective incoming edges. Such embodiments foster consensus by punishing incoming edges whose predictions are too far from the current reference value at the respective node. In one such example, a weight corresponding to an incoming edge may be determined according to:

$${W}_{s \to d}^{i} = \frac{K [ dist ( {P}_{s \to d}^{i} , {A}_{d}^{i} ) ]}{{\sum }_{s} K [ dist ( {P}_{s \to d}^{i} , {A}_{d}^{i} ) ]} , \qquad [ 1 ]$$

wherein subscripts s and d denote a source node and a destination node, respectively, A_{d} denotes the initial reference attribute value at node d, P_{s->d} denotes the prediction value produced by the edge from s to d, and K denotes a kernel function such as the Gaussian. Depending on the type of attribute A_{d}, there may be various ways to compute the distance, for instance an L¹ or L² norm for numerical attributes, a Levenshtein distance for character strings, etc. The index i runs through all training samples (i.e., there may be a distinct value of the weight determined for each training sample). Furthermore, when node attributes comprise arrays of values, there may be a distinct value of the weight for each element of the attribute array. For instance, in an image processing embodiment, there may be a distinct weight value W_{s→d}ⁱ(x,y) for each distinct pixel (x,y) of each distinct training image.

An alternative manner of fostering consensus may favor incoming edges whose predictions are close together, irrespective of whether they are also close to a current reference value. In such embodiments, a measure of consensus may be determined according to a set of distances between prediction values determined by distinct edges, or according to a distance between each prediction value and an average prediction computed over all edges converging onto the respective node. In one such example, an edge weight may be determined according to:

$${W}_{s \to d}^{i} = \frac{K [ dist ( {P}_{s \to d}^{i} , {\hat{P}}_{d}^{i} ) ]}{{\sum }_{s} K [ dist ( {P}_{s \to d}^{i} , {\hat{P}}_{d}^{i} ) ]} , \qquad [ 2 ]$$

wherein \hat{P}_{d} denotes an average prediction of all edges converging onto node d. Some embodiments may use a combination of the weights determined according to [1] and [2].

By updating the reference attribute value of each node in a manner that fosters consensus, some embodiments effectively incorporate consensus-building into the training procedure. Having provided new edge end-values to be learned, some embodiments re-enter the cycle of edge training (steps 104-110). The sequence of edge training—consensus-building reference update may be repeated until a termination condition is satisfied (step 114). Training concludes with the output of detector parameter values 24 (step 116).

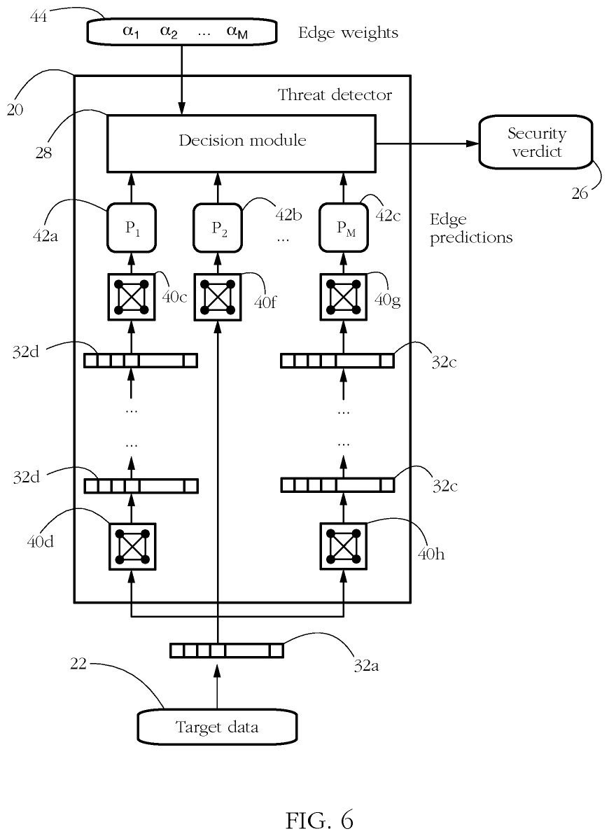

FIG. 6 illustrates an exemplary architecture of threat detector 20. In some embodiments, detector 20 incorporates an instance of multitask graph 50, including all modules 40a-h of graph 50, arranged in the same topology. However, threat detector 20 takes a particular view of graph 50 by singling out an output node and an input node. Stated otherwise, threat detector 20 implements multitask graph 50 from the perspective of a selected task associated with the selected output node. Furthermore, detector 20 receives input via the selected input node of multitask graph 50. In the exemplary embodiment illustrated using FIGS. 3 and 6, the input node is node 30a, and the output node is node 30e. Input node 30a receives attribute set 32a comprising a set of features determined according to target data 22. In a simple embodiment, attribute set 32a comprises target data 22 itself.

In computer security embodiments, the task associated with output node 30e may comprise determining whether target data 22 is indicative of a computer security threat. To achieve this task, some embodiments execute modules 40a-h, progressively traversing multitask graph 50 from input node 30a to output node 30e.

Each module 40a-h computes a prediction value for a data attribute associated with the destination node according to a value of another data attribute associated with the source node of the respective edge. Therefore, traversing graph 50 typically comprises starting at input node 32a and progressively evaluating attributes associated with intermediary nodes on the way to output node 32e. When a node has multiple incoming edges, some embodiments determine the respective to node attribute value(s) by combining predictions produced by individual incoming edges. For instance, the respective attribute value(s) may be determined according to a weighted average of individual edge predictions:

A_{d}˜Σₛ(P_{s→d}·α_{s→d}), [3]

wherein P_{s→d} denotes the respective prediction determined by the AI module associated with edge s→d, and α_{s→d} denotes an edge-specific weight of the respective edge. Some embodiments calculate weights α_{s→d} according to weights W_{s→d}ⁱ determined during training (see equations [1] and [2] above). For instance, α_{s→d} may be determined as an average of W_{s→d}ⁱ over all training samples i.

An alternative embodiment of threat detector 20 may implement a consensus-building strategy for determining attribute values, similar to the one described above in relation to training multitask graph 50. In one such example, each intermediary node of detector 20 is initialized with an attribute value determined for instance by a selected edge ending in the respective node. A further iteration then recomputes the attribute value(s) at each node according to the initial attribute value(s), but this time taking into account all incoming edges at the respective node. The prediction values of individual incoming edges may be combined, each prediction given a relative weight determined for instance according to how far the respective prediction is with respect to the initial/current value at the respective node, and/or according to how far the respective prediction is with respect to an average prediction for all incoming edges (see e.g., discussion above in relation to equations [1] and [2]).

FIG. 6 shows edge predictions 42a-c comprising predicted values of attribute(s) 32e at output node 30e of multitask graph 50. In some embodiments, each prediction 42a-c is a partial security verdict, indicating for instance a likelihood that target data 22 is indicative of a computer security threat. In some embodiments, a decision module 28 of detector 20 may combine individual predictions 42a-c into an aggregate value for attribute(s) 32e, and determine security verdict 26 according to the aggregate attribute value. Decision module 28 may combine individual predictions 42a-c according to a set of edge weights 44, as described above. In some embodiments, weights 44 form a part of detector parameter values 24 output by training appliance 14 as a result of training.

Exemplary embodiments of threat detector 20 described above comprise an instance of the whole of multitask graph 50, i.e., all modules 40a-h interconnected in the same manner as during training. Stated otherwise, such a detector implements all possible paths of traversing multitask graph 50 from input node 32a to output node 32b, along its directed edges. Several other, simpler architectures of threat detector 20 may be imagined. For instance, an alternative architecture of detector 20 may implement a restricted subset of paths connecting the input and output nodes. Such embodiments rely on the assumption that by being co-trained with all the discarded nodes and edges, the selected remaining nodes and edges have incorporated at least some of the extra ‘knowledge’ provided by the discarded components of multitask graph 50, including by the consensus-building training as described above. A basic detector 20 may employ only one edge/AI module directly connecting the input and output nodes (e.g. edge 40f in FIG. 3). A more sophisticated detector may implement two paths, for instance one comprising edge 40f and another one comprising the sequence of edges 40d-40c, etc. Such embodiments may allow a fast, efficient calculation of security verdict 26, but may be less reliable (e.g., produce more false positives) than embodiments using the full multitask graph used in training.

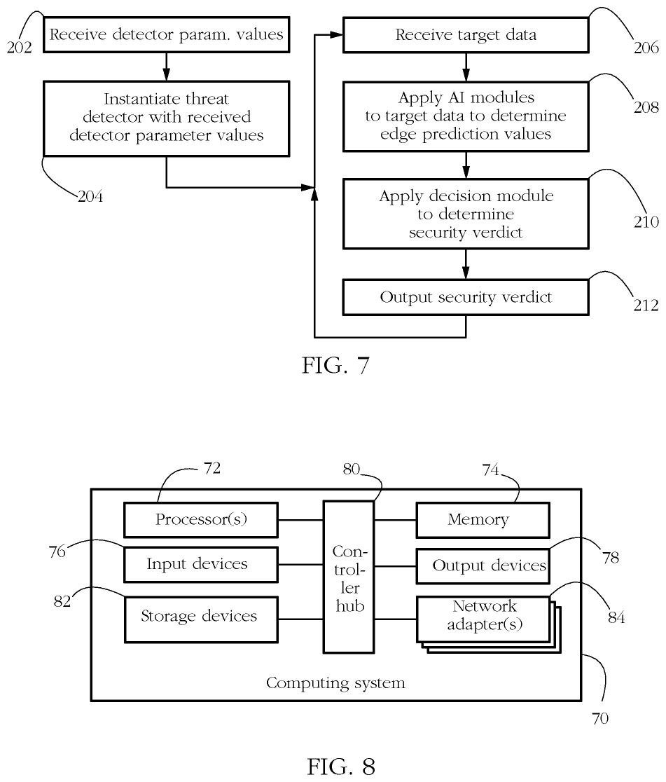

FIG. 7 shows an exemplary sequence of steps performed by detector 20 to protect a client system against computer security threats according to some embodiments of the present invention. A sequence of steps 202-204 receives parameter values 24 and instantiates detector 20 with the respective parameter values. In some embodiments, parameter values 24 include values of internal parameters of AI modules 40a-h (e.g., synapse weights, etc.), as well as other training parameters such as consensus weights W_{s→d}ⁱ, among others. In some embodiments, step 204 effectively recreates within detector 20 an instance of a fully trained multitask graph 50, as described above.

A step 206 may receive target data 22. When detector 20 operates remotely, for instance on security server 12, step 206 may comprise receiving data 22 over a communication network. Some embodiments accumulate target data 22 received from multiple clients and send it to detector 20 in batches. Step 206 may further comprise employing a feature extractor to determine input attributes 32a according to target data 22 (see e.g., FIG. 6). In a further step 208, detector 20 applies its internal AI modules 40a-h as described above, to traverse multitask graph 50 from the input to the output node. A further sequence of steps 210-212 may apply decision module to produce and output security verdict 26, respectively. Verdict 26 may then be communicated to the respective client system 10a-c and/or to a system administrator, etc.

FIG. 8 shows an exemplary hardware configuration of a computing system 70 programmed to execute some of the methods described herein. Computing system 70 may represent any of client systems 10a-c, security server 12, and AI training appliance 14 in FIG. 1. The illustrated computing appliance is a personal computer; other devices such as servers, mobile telephones, tablet computers, and wearables may have slightly different configurations. Processor(s) 72 comprise a physical device (e.g. microprocessor, multi-core integrated circuit formed on a semiconductor substrate) configured to execute computational and/or logical operations with a set of signals and/or data. Such signals or data may be encoded and delivered to processor(s) 72 in the form of processor instructions, e.g., machine code.

Processors 72 are generally characterized by an instruction set architecture (ISA), which specifies the respective set of processor instructions (e.g., the x86 family vs. ARM® family), and the size of registers (e.g., 32 bit vs. 64 bit processors), among others. The architecture of processors 72 may further vary according to their intended primary use. While central processing units (CPU) are general-purpose processors, graphics processing units (GPU) may be optimized for image/video processing and some forms of parallel computing. Processors 72 may further include application-specific integrated circuits (ASIC), such as Tensor Processing Units (TPU) from Google®, Inc., and Neural Processing Units (NPU) from various manufacturers. TPUs and NPUs may be particularly suited for machine learning applications as described herein.

Memory unit 74 may comprise volatile computer-readable media (e.g. dynamic random-access memory—DRAM) storing data/signals/instruction encodings accessed or generated by processor(s) 72 in the course of carrying out operations. Input devices 76 may include computer keyboards, mice, and microphones, among others, including the respective hardware interfaces and/or adapters allowing a user to introduce data and/or instructions into appliance 70. Output devices 78 may include display devices such as monitors and speakers among others, as well as hardware interfaces/adapters such as graphic cards, enabling the respective computing appliance to communicate data to a user. In some embodiments, input and output devices 76-78 share a common piece of hardware (e.g., a touch screen). Storage devices 82 include computer-readable media enabling the non-volatile storage, reading, and writing of software instructions and/or data. Exemplary storage devices include magnetic and optical disks and flash memory devices, as well as removable media such as CD and/or DVD disks and drives. Network adapter(s) 84 enable computing appliance 70 to connect to an electronic communication network (e.g, network 15 in FIG. 1) and/or to other devices/computer systems.

Controller hub 80 generically represents the plurality of system, peripheral, and/or chipset buses, and/or all other circuitry enabling the communication between processor(s) 72 and the rest of the hardware components of appliance 70. For instance, controller hub 80 may comprise a memory controller, an input/output (I/O) controller, and an interrupt controller. Depending on hardware manufacturer, some such controllers may be incorporated into a single integrated circuit, and/or may be integrated with processor(s) 72. In another example, controller hub 80 may comprise a northbridge connecting processor 72 to memory 74, and/or a southbridge connecting processor 72 to devices 76, 78, 82, and 84.

The exemplary systems and methods described above facilitate the automatic detection of computer security threats such as malware and intrusion (hacking). Some modern computer security systems rely on artificial intelligence and machine learning technologies to keep up with rapidly emerging threats. In a version of machine learning commonly known as supervised learning, neural networks may be trained on a corpus of data harvested from victims of various known attacks, and may then be deployed to protect other clients against such attacks. Such approaches rely on the capability of neural networks to generalize from learned data, so that trained networks may perform satisfactorily even in the face of previously unseen attack strategies. However, exposing a network only to known forms of malware does not guarantee performance under new circumstances.

Machine learning is typically expensive, requiring vast amounts of computing power and memory. Supervised learning puts an extra burden by requiring the availability of annotated training corpora. Annotation herein refers to providing metadata that enables the AI system undergoing training to distinguish between benign and malicious training data. Annotation typically requires human supervision, which is expensive and relatively slow. Furthermore, it cannot be proactive since it does not apply to previously unseen attacks.

In contrast to such conventional supervised training, some embodiments of the present invention rely on a self-supervised machine learning strategy that uses consensus to push training beyond purely supervised learning. Some embodiments co-train a multitask graph comprising a plurality of nodes interconnected by directed edges. Each node corresponds to a distinct task comprising determining a distinct set of attributes of input data. In a computer security embodiment, the respective attributes may be malware-indicative. Each edge comprises a distinct AI module (which may include a trainable AI system such as a deep neural network) configured to determine attributes of the destination node according to attributes of the source node of the respective edge. Therefore, the multitask graph collectively computes a plurality of ‘views’ of the input data, each view revealing a distinct set of attributes of the respective data.

Some embodiments rely on the observation that looking at the same data from multiple view points is likely to improve threat detection. Therefore, some embodiments combine individual views by having a richly connected multitask graph, wherein at least a subset of nodes have multiple incoming edges, i.e., multiple ways of determining the attribute associated with the respective node. Some embodiments further rely on the observation that since individual edges converging to the same node are in essence different ways of computing the same attribute(s), the values determined by all incoming edges should coincide. Therefore, a consensus between incoming edges may be used as an indicator that values determined by individual edges are correct. This observation allows moving away from a strictly supervised training paradigm wherein each edge is trained to produce a desired value to a semi-supervised paradigm wherein all edges converging to a node are actively coaxed to produce the same output. Such an approach removes at least in part the burden of annotation (which in this case would correspond to providing the ‘correct’ attribute value), allowing some embodiments to achieve better threat detection performance on data not seen in training. Some embodiments pre-train the detector using supervised learning (for instance relying on a set of expert systems to provide annotations), and then use consensus-driven self-supervised training to further enhance the performance of the detector.

Some conventional AI systems train a single large neural network as a threat detector, relying on the network to extract and construct its own features, attributes and representations of the input data. Although such approaches have shown moderate success, various experiments have shown that achieving a truly high detection performance may require an impractically large neural network, for instance having many millions of adjustable parameters. Training and deploying such detectors are inherently expensive. In contrast to such monolithic solutions, some embodiments of the present invention use a plurality of interconnected individual transformation AI modules, each representing an edge of the multitask graph. Such modules may be orders of magnitude smaller than the single network used in conventional approaches, so training them to a comparable performance may incur only a fraction of the cost of training a monolithic network. Furthermore, individual modules may be trained independently of each other for at least a part of the training procedure, which allows using parallel computing to further speed up training.

The systems and methods illustrated herein have also proven useful beyond computer security. One exemplary alternative embodiment may be used in image processing, for instance to carry out automatic image segmentation. In such applications, the input data may comprise a array of pixels (e.g. an RGB image). Nodes 30a-e (FIG. 3) may represent various image processing tasks, such as edge detection, extraction of surface normals, image depth, transformation to grayscale, semantic segmentation, etc. Computer experiments have shown that consensus-building training as shown herein provides a substantial boost in performance over conventional methods, of the order of 8-12% on tasks such as surface normals and semantic segmentation.

It will be clear to one skilled in the art that the above embodiments may be altered in many ways without departing from the scope of the invention. Accordingly, the scope of the invention should be determined by the following claims and their legal equivalents.

What is claimed is:

1. A computer security method comprising employing at least one hardware processor of a computer system to:
train a plurality of neural network (NN) modules of a graph interconnecting a plurality of nodes, each node representing a distinct attribute of a set of input data, wherein each edge comprises a distinct NN module configured to evaluate an attribute associated with an end node of the respective edge according to an attribute associated with a start node of the respective edge, wherein a selected node receives a plurality of incoming edges, all edges of the plurality of incoming edges configured to evaluate a selected attribute associated with the selected node, and wherein training comprises:
determining a plurality of values of the selected attribute, each value determined by a NN module associated with a distinct edge of the plurality of incoming edges, and
adjusting a parameter of the NN module according to a measure of consensus of the plurality of values; and
in response to training the plurality of NN modules, transmit an adjusted value of the parameter to a threat detector configured to employ another instance of the NN module to determine whether a set of target data is indicative of a computer security threat.

2. The method of claim 1, wherein training comprises adjusting parameters of NN modules associated with the plurality of incoming edges to bring the plurality of values of the selected attribute closer together.

3. The method of claim 1, wherein the measure of consensus is determined according to a distance between each value of the plurality of values and a reference value of the selected attribute.

4. The method of claim 3, wherein the reference value of the selected attribute is determined by an expert model according to the training sample, the expert model distinct from the plurality of NN modules.

5. The method of claim 3, wherein the reference value comprises a selected value of the plurality of values.

6. The method of claim 3, wherein the reference value of the selected attribute comprises an average of the plurality of values.

7. The method of claim 1, further comprising employing at least one hardware processor of the computer system to execute the threat detector.

8. The method of claim 1, wherein the set of target data comprises a web page, and wherein the threat detector is configured to determine whether the web page comprises malicious content.

9. The method of claim 1, wherein the set of target data comprises an indicator of a computer process, and wherein the threat detector is configured to determine whether the computer process comprises malware.

10. A computer system comprising at least one hardware processor configured to:
train a plurality of NN modules of a graph interconnecting a plurality of nodes, each node representing a distinct attribute of a set of input data, wherein each edge comprises a distinct NN module configured to evaluate an attribute associated with an end node of the respective edge according to an attribute associated with a start node of the respective edge, wherein a selected node receives a plurality of incoming edges, all edges of the plurality of incoming edges configured to evaluate a selected attribute associated with the selected node, and wherein training comprises:
determining a plurality of values of the selected attribute, each value determined by a NN module associated with a distinct edge of the plurality of incoming edges, and
adjusting a parameter of the NN module according to a measure of consensus of the plurality of values; and
in response to training the plurality of NN modules, transmit an adjusted value of the parameter to a threat detector configured to employ another instance of the NN module to determine whether a set of target data is indicative of a computer security threat.

11. The computer system of claim 10, wherein training comprises adjusting parameters of NN modules associated with the plurality of incoming edges to bring the plurality of values of the selected attribute closer together.

12. The computer system of claim 10, wherein the measure of consensus is determined according to a distance between each value of the plurality of values and a reference value of the selected attribute.

13. The computer system of claim 12, wherein the reference value of the selected attribute is determined by an expert model according to the training sample, the expert model distinct from the plurality of NN modules.

14. The computer system of claim 12, wherein the reference value comprises a selected value of the plurality of values.

15. The computer system of claim 12, wherein the reference value of the selected attribute comprises an average of the plurality of values.

16. The computer system of claim 10, wherein the at least one hardware processor is further configured to execute the threat detector.

17. The computer system of claim 10, wherein the set of target data comprises a web page, and wherein the threat detector is configured to determine whether the web page comprises malicious content.

18. The computer system of claim 10, wherein the set of target data comprises an indicator of a computer process, and wherein the threat detector is configured to determine whether the computer process comprises malware.

19. A non-transitory computer readable medium storing instructions which, when executed by at least one hardware processor of a computer system, cause the computer system to:
train a plurality of NN modules of a graph interconnecting a plurality of nodes, each node representing a distinct attribute of a set of input data, wherein each edge comprises a distinct NN module configured to evaluate an attribute associated with an end node of the respective edge according to an attribute associated with a start node of the respective edge, wherein a selected node receives a plurality of incoming edges, all edges of the plurality of incoming edges configured to evaluate a selected attribute associated with the selected node, and wherein training comprises:
determining a plurality of values of the selected attribute, each value determined by a NN module associated with a distinct edge of the plurality of incoming edges, and
adjusting a parameter of the NN module according to a measure of consensus of the plurality of values; and
in response to training the plurality of NN modules, transmit an adjusted value of the parameter to a threat detector configured to employ another instance of the NN module to determine whether a set of target data is indicative of a computer security threat.
